(19) United States
(12) Patent Application Publication
(10) Pub. No.: US 2010/0307374 A1
(43) Pub. Date: Dec. 9, 2010

(54) CONTAINER COVER SYSTEM

(76) Inventor: John David Kalal, Aujohoga Falls, OH (US)

Correspondence Address: Emerson, Thomson & Bennett, LLC, 1914 Akron-Peninsula Road, Akron, OH, 44313, US

(21) Appl. No.: 12/775,194

(22) Filed: May 6, 2010

Related U.S. Application Data
(60) Provisional application No. 61/175,988, filed on May 6, 2009.

(51) Int. Cl. B61D 39/00; B60P 7/04; B65D 51/24

(52) U.S. Cl. 105/377.02; 105/377.01; 220/212

(57) ABSTRACT

A cover system suitable to cover an open topped container may include a cover and an attachment system. The cover may include a channel pocket that is attached to the cover and that extends across a portion of the cover. The attachment system may include a strap that is received within the channel pocket and that has ends that are attachable to the container.

This application claims priority to U.S. Ser. No. 61/175,988, entitled RAILCAR COVER SYSTEM, filed May 6, 2009, which is incorporated herein by reference.

### I. BACKGROUND OF THE INVENTION

A. Field of Invention

This invention relates generally to tarp systems including fabric or other materials and associated implements for covering an open topped container such as truck boxes, railcars, other vehicle containers and stationary containers.

B. Description of the Related Art

It is well known in the art to provide various types of containers that are designed to be loaded through an open top. Non-limiting examples include trucks, trailers, railcars, other moveable containers and stationary containers. Such containers are typically used to haul or store various contents such as hardware, equipment, produce, grain, stones, sand, earth and refuse.

It is known to use tarpaulins or other coverings to enclose the open tops of such containers. The tarpaulins serve to shelter the truck, trailer or container contents against the elements and to maintain the contents in the body. Several systems are known for covering the open tops of vehicles, boxes and containers with tarpaulins.

What is needed is an improved cover system.

### II. SUMMARY OF THE INVENTION

According to one embodiment of this invention, a cover system suitable to cover an associated open topped railcar may include: a cover comprising: first and second sides that define a width; first and second ends that define a length; and, a channel pocket that is attached to the cover and that extends across at least a portion of one of the width and the length of the cover. The cover may be of sufficient size to enclose the open top of the associated open topped railcar. The cover system may also include an attachment system that is suitable to attach the cover to the associated open topped railcar. The attachment system may comprise a strap that is received within the channel pocket and that comprises first and second ends that are attachable to the associated open topped railcar.

According to another embodiment of this invention, a cover system suitable to cover an associated open topped container may comprise a cover comprising: first and second sides that define a width; first and second ends that define a length; a first channel pocket that is fixed to the cover and that extends across at least a portion of the width of the cover; and, a second channel pocket that is fixed to the cover and that extends across at least a portion of the length of the cover. The cover may be of sufficient size to enclose the open top of the associated open topped container. The cover system may also include an attachment system that is suitable to attach the cover to the associated open topped container. The attachment system may comprise: a first strap that is received within the first channel pocket and that comprises first and second ends that are attachable to the associated open topped container; and, a second strap that is received within the second channel pocket and that comprises first and second ends that are attachable to the associated open topped container.

According to yet another embodiment of this invention, a cover system suitable to cover an associated open topped container may comprise a cover comprising: first and second sides that define a width; first and second ends that define a length; first and second channel pockets that are welded to the cover and that extend across at least 50% of the width of the cover; and, a third channel pocket that is welded to the cover and that extends across at least 50% of the length of the cover. The perimeter of the cover may comprise webbing reinforced in a hem over at least 50% of the perimeter of the cover. The cover may be of sufficient size to enclose the open top of the associated open topped container. The cover system may also include an attachment system that is suitable to attach the cover to the associated open topped container. The attachment system may comprise: a first strap that is received within the first channel pocket and that comprises first and second ends that are attachable to the associated open topped container; a second strap that is received within the second channel pocket and that comprises first and second ends that are attachable to the associated open topped container; and, a third strap that is received within the third channel pocket and that comprises first and second ends that are attachable to the associated open topped container. Each of the first and second ends of the first, second and third straps may comprise: a main strap portion; an extension portion comprising a first end that is attachable to the associated open topped container and a second end; and, a tightening device that attaches the second end of the extension portion to the main strap portion and that is adjustable to increase the tension of the corresponding strap.

One advantage of this invention is a cover system may include a cover and an integral attachment system that makes it virtually impossible to misplace attachment devices.

Another advantage of this invention is that a cover may be provided with numerous attachment devices so that it is well equipped to be used with numerous types and styles of containers.

Another advantage of this invention is that a cover may be easily attached to and removed from a container.

Still another advantage of this invention is that channel pockets may be attached to the cover in a welding process making the cover virtually water proof.

Yet another advantage of this invention is that the cover may be flexible or may be a hard tarp.

Other benefits and advantages will become apparent to those skilled in the art to which it pertains upon reading and understanding of the following detailed specification.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a side view of a railcar that may be equipped with a cover system according to this invention.

FIG. 2 is a top view of the railcar shown in FIG. 1.

FIG. 3 is a top view of a cover system according to one embodiment of this invention.

FIG. 4 is an exploded view of section area A from FIG. 3.

FIG. 5 is an exploded view of section area B from FIG. 3.

FIG. 6 is an exploded view of the upper left hand corner portion of the cover system from FIG. 3.

FIG. 7 is an exploded view of the lower left hand corner portion of the cover system from FIG. 3.

FIG. 8 is an exploded view of section area C from FIG. 3.

### IV. DETAILED DESCRIPTION OF THE INVENTION

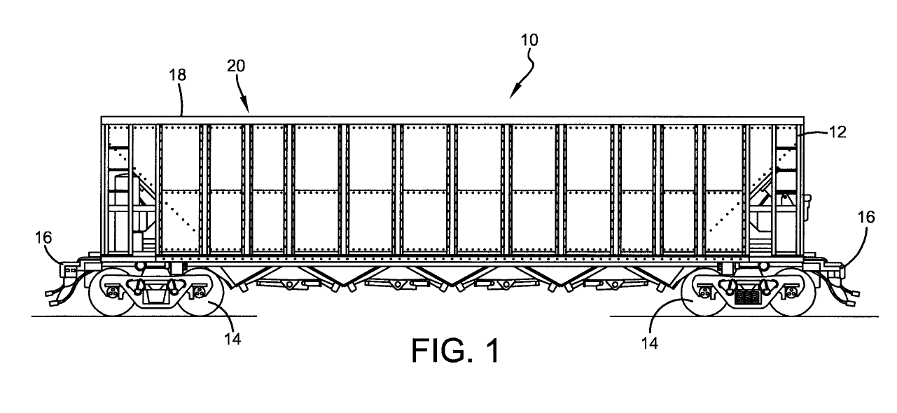

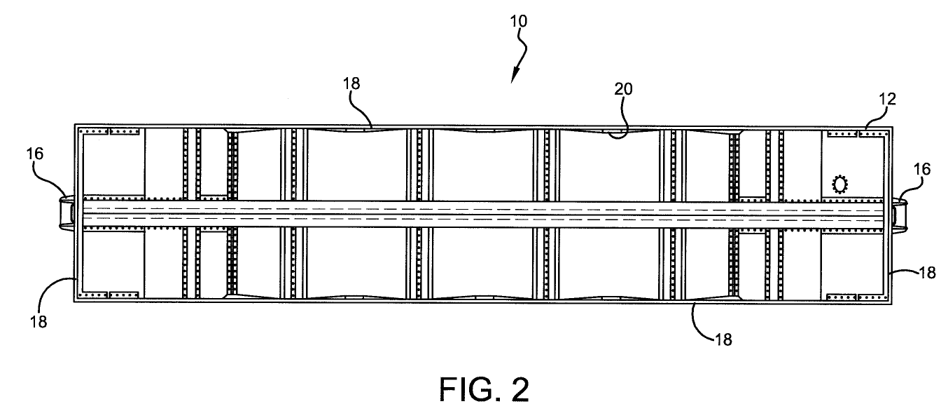

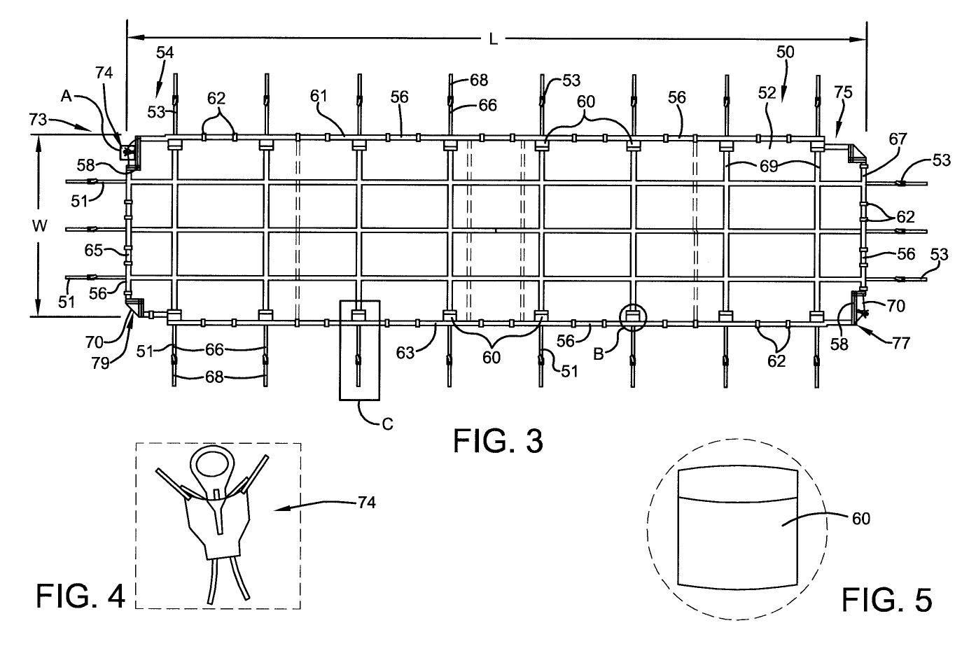

Referring now to the drawings wherein the showings are for purposes of illustrating embodiments of the invention only and not for purposes of limiting the same, and wherein like reference numerals are understood to refer to like components, FIGS. 1 and 2 show a container 10 that may be equipped with a cover system 50, shown in FIG. 3, according to one embodiment of this invention. While the container 10 shown in FIGS. 1 and 2 is a railcar, it is to be understood that the cover system 50 of this invention will work with any container chosen with the sound judgment of a person of skill in the art including, for some non-limiting examples, trucks, trailers, other moveable containers and stationary containers. The railcar 10 may include a body 12, one or more rail engaging wheels 14 operatively mounted to the body 12, and at least one coupler 16 mounted to the body 12 for use in connecting the railcar to other railcars in any known manner The body 12 may have vertically extending walls 18 defining an opening 20 position on the top of the railcar 10. The container may have one or more attachment surfaces (not referenced) to which the cover system 50 is attached. The attachment surfaces may be, for some non-limiting examples, channel bars, hooks and rails. As the attachment surfaces are well known to those of skill in the art, further details will not be provided here. The cover system 50 may be used to cover the opening 20 and thereby cover any contents stored inside the railcar 10.

With reference now to FIGS. 1-3, the cover system 50 may include a cover 52 and an attachment system 54 that is used to attach the cover 52 to the container 10. The cover 52 may be of any design and material chosen with the sound judgment of a person of skill in the art. In one embodiment the cover is flexible. In another embodiment the cover is not flexible. For the embodiment shown, the cover 52 is a tarpaulin. The tarpaulin may be formed of plastic, fabric or a combination of plastic and fabric materials. Thus the tarpaulin may be flexible or may be formed of a hard tarp material. As the general making of tarpaulins is well known to those of skill in the art, further details will not be provided here. The cover 52 may have any shape and size suitable to enclose the opening 20 in the container 10. For the embodiment shown, the cover 52 is rectangular in shape having first and second sides 61, 63 defining a width W and first and second ends 65, 67 defining a length L. The sides 61, 63 and ends 65, 67 may define corner regions 73, 75, 77, 79.

With reference now to FIGS. 3 and 6-7, the cover 52 may have one or more channel pockets 69 that are attached to the cover 52 and that extend across at least a portion of the width W of the cover 52. Similarly, the cover 52 may have one or more channel pockets 71 that are attached to the cover 52 and that extend across at least a portion of the length of the cover 52. The channel pockets 69, 71 may be used for purposes discussed further below. In one embodiment, the channel pockets 69, 71 extend across at least 50% of the width W and length L of the cover 52, respectively. In another embodiment, shown, the channel pockets 69, 71 extend across the entire width W and length L of the cover 52, respectively. The channel pockets can be of any size and shape chosen with the sound judgment of a person of skill in the art and may be attached to the cover 52 in any manner chosen with the sound judgment of a person of skill in the art and may be attached to the cover 52. In one embodiment, the channel pockets 69, 71 are fixed to the cover 52 in a sewing process. In another embodiment, the channel pockets 69, 71 are welded to the cover 52. As known by those of skill in the art, the welding process eliminates the need for stitching and makes the cover 52 virtually water proof thereby better protecting the contents of the container 10.

With continuing reference to FIGS. 3 and 6-7, the cover 52 may include areas of webbing reinforced in a hem 56 to improve the strength of the cover 52 at areas of need (especially the outer edges and corners). Some of the areas of webbing reinforced in a hem 56 may have double webbing (side by side, as shown, or on top of each other) reinforced in a hem 58. In one embodiment, the perimeter of the cover 52 includes webbing reinforced in a hem 56 or 58 over at least 50% of the perimeter of the cover 52. In another embodiment, shown, the perimeter of the cover 52 includes webbing reinforced in a hem 56 around the entire perimeter of the cover 52. The webbing reinforcements 56, 58 may be made in any manner chosen with the sound judgment of a person of skill in the art. In one embodiment, the webbing reinforcements 56, 58 are sown into the cover 52. The cover 52 may also include one or more storage pouches or pockets 60 that may be attached to the cover 52, such as by sewing. The storage pouches 60 may be used for purposes discussed further below. In one specific embodiment, the storage pouches 60 may be sown to the inside (facing downward) of the cover 52.

With reference now to FIGS. 1-7, the attachment system 54 may include several attachment devices making the cover system 50 suitable for use with containers 10 of various types. It is to be understood that some or all of the attachment devices may be used in any particular application. In one embodiment, the attachment devices may include one or more attachment rings 62 attached to the outer edges of the cover 52. For the embodiment shown, the attachment rings 62 are D-rings and are sewn onto the cover 52.

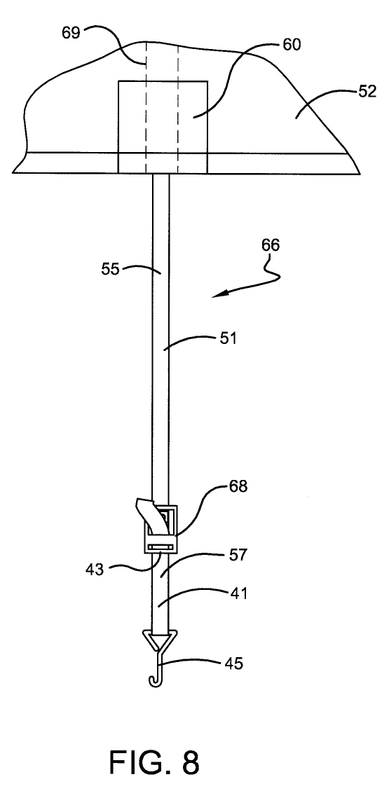

With reference now to FIGS. 3 and 8, in another embodiment, the attachment devices may include one or more straps 66 that are received in the channel pockets 69, 71. Each strap 66 may have first and second ends 51, 53 that are attachable to the container 10. In one embodiment, the strap 66 is fixed to the cover 52, such as by sewing. In another embodiment, the strap 66 is free floating with respect to the cover 52. In this case, the strap 66 can be moved within the channel pocket 69 or 71 to accommodate the container 52. In one embodiment, at least one of the ends 51, 53 of the strap 66 includes a main strap portion 55 and an extension portion 57. The extension portion 57 may have a first end 41 that is attachable to the container 10 and a second end 43. In one embodiment an attachment device 45, such as a rail car clip, a metal S-hook; and the like, may be connected to the first end 41 of the extension portion 57 and used to attach the strap 66 to the container 10. A tightening device 68 may be used to attach the second end 43 of the extension portion 57 to the main strap portion 55. The tightening device 68 may be adjustable and used to increase the tension of the strap 66. The tightening device 68 can be of any type and size chosen with the sound judgment of a person of skill in the art. In one embodiment, the tightening device 68 may operate similar to a vehicle seat belt system. The previously mentioned storage pouches 60 may be positioned on the cover 52 near the locations where the straps 66 are attached to the cover 52. In this way the storage pouches 60 are conveniently positioned for use as a storage compartment for the ends of straps that are not being used.

With reference now to FIGS. 3-4 and 6-7, the attachment devices may include one or more attachment cords 70 attached to the outer edges of the cover 52. For the embodiment shown, the attachment cords 70 are positioned on the four corner regions 73, 75, 77, 79 of the cover 52. The attachment cords 70 may be of any design and material chosen with the sound judgment of a person of skill in the art. Some non-limiting examples include ropes, nylon cording, drawstrings, bungee cords, and shock cords. In one embodiment, the attachment cords 70 are elastic making them relatively easy to stretch to connect to the container 10. One embodiment of an attachment cord design is shown in FIG. 7. As there shown, each end of the attachment cord 70 is sewn to a portion of the cover 52 and includes a mid-portion 72 that extends beyond the cover 52. While the amount of cord 70 sewn into the cover 52 can be any chosen with the sound judgment of a person of skill in the art, for the embodiment shown in FIG. 7, about 12 inches of each end of the attachment cord 70 is sewn into the cover 52. This provides a stable and strong attachment. The extending mid-portion 72 may be referred to as an exposure section as it is exposed outside of the cover 52. While the amount of exposure can be any chosen with the sound judgment of a person of skill in the art, for the embodiment shown in FIG. 7, the exposure section 72 is about 12 inches of the attachment cord 70.

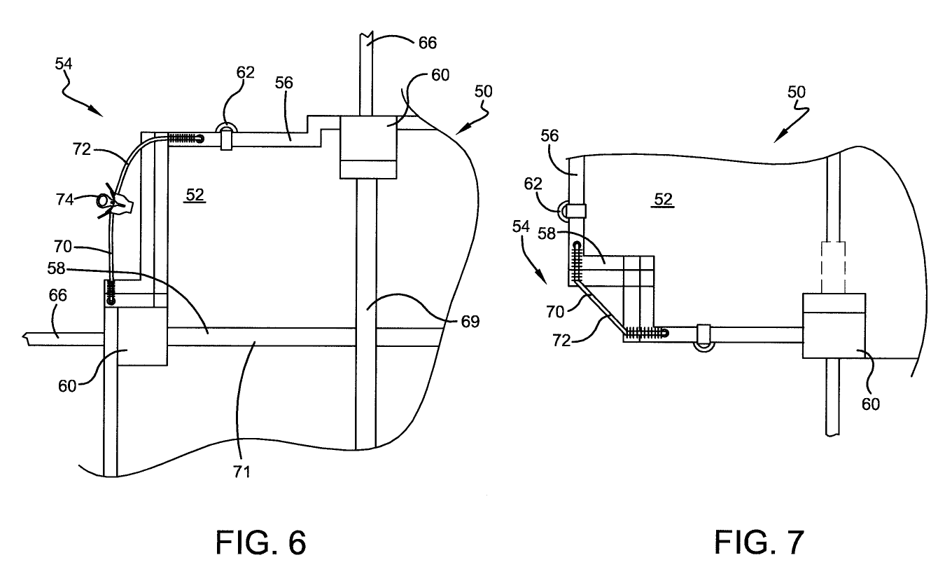

Another embodiment of an attachment cord design is shown in FIG. 6. As with the previous embodiment, each end of the attachment cord 70 is sewn to a portion of the cover 52 and includes an exposure section 72 that extends beyond the cover 52. While the amount of cord 70 sewn into the cover 52 can be any chosen with the sound judgment of a person of skill in the art, for the embodiment shown in FIG. 6 as with the embodiment shown in FIG. 7, about 12 inches of each end of the attachment cord 70 is sewn into the cover 52. This provides a stable and strong attachment. While the amount of exposure can be any chosen with the sound judgment of a person of skill in the art, for the embodiment shown in FIG. 6, the exposure section 72 is about 24 inches of the attachment cord 70. The attachment cord design shown in FIG. 6 also may include a cord lock 74. The cord lock 74 may be of any type and size chosen with the sound judgment of a person of skill in the art and may be used to increase or decrease the length of exposure section 72. In this way, the attachment cord 70 can be adjusted to provide variations in the effective length. In one specific embodiment, the attachment system 54 may use the attachment cord design shown in FIG. 7 on opposite corners (upper right and lower left corners, as shown) and may use the attachment cord design shown in FIG. 6 on remaining opposite corners (upper left and lower right corners, as shown). It should be noted that the attachment cords 70 reduce the amount of cover 52 material required and greatly reduce the unwanted resulting bunching that occurs with known covers.

Numerous embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

1. A cover system suitable to cover an associated open topped railcar, the cover system comprising:
a cover comprising:
first and second sides that define a width;
first and second ends that define a length;
a channel pocket that is attached to the cover and that extends across at least a portion of one of the width and the length of the cover;
wherein the cover is of sufficient size to enclose the open top of the associated open topped railcar; and,
an attachment system that is suitable to attach the cover to the associated open topped railcar, the attachment system comprising:
a strap that is received within the channel pocket and that comprises first and second ends that are attachable to the associated open topped railcar.

2. The cover system of claim 1 wherein:
the cover comprises: a second channel pocket that is attached to the cover and that extends across at least a portion of the other of the width and the length of the cover; and,
the attachment system comprises: a second strap that is received within the second channel pocket and that comprises first and second ends that are attachable to the associated open topped railcar.

3. The cover system of claim 1 wherein the channel pocket is attached to the cover in a welding process.

4. The cover system of claim 1 wherein the strap is fixed to the cover.

5. The cover system of claim 1 wherein the strap is free floating with respect to the cover.

6. The cover system of claim 1 wherein the cover is flexible.

7. The cover system of claim 1 wherein the cover is formed substantially of a hard tarp material.

8. The cover system of claim 1 wherein at least one of the first and second ends of the strap comprises:
a main strap portion;
an extension portion comprising a first end that is attachable to the associated open topped railcar and a second end; and,
a tightening device that attaches the second end of the extension portion to the main strap portion and that is adjustable to increase the tension of the strap.

9. The cover system of claim 1 wherein the cover comprises at least one storage pouch that is suitable to hold one of the first and second ends of the strap when the one of the first and second ends of the strap is not attached to the associated open topped railcar.

10. The cover system of claim 1 wherein the attachment system comprises:
an attachment cord having first and second ends that are attached to the cover and a mid-portion that is exposed outside of the cover and that is attachable to the associated open topped railcar.

11. The cover system of claim 10 wherein:
the attachment cord is elastic; and,
the attachment system comprises a cord lock that is adjustable to increase and decrease the length of the mid-portion of the attachment cord.

12. A cover system suitable to cover an associated open topped container, the cover system comprising:
a cover comprising:
first and second sides that define a width;
first and second ends that define a length;
a first channel pocket that is fixed to the cover and that extends across at least a portion of the width of the cover;
a second channel pocket that is fixed to the cover and that extends across at least a portion of the length of the cover;
wherein the cover is of sufficient size to enclose the open top of the associated open topped container; and,
an attachment system that is suitable to attach the cover to the associated open topped container, the attachment system comprising:
a first strap that is received within the first channel pocket and that comprises first and second ends that are attachable to the associated open topped container; and,
a second strap that is received within the second channel pocket and that comprises first and second ends that are attachable to the associated open topped container.

13. The cover system of claim 12 wherein the perimeter of the cover comprises webbing reinforced in a hem over at least 50% of the perimeter of the cover.

14. The cover system of claim 13 wherein each of the first and second ends of the first and second straps comprises:
a main strap portion;
an extension portion comprising a first end that is attachable to the associated open topped container and a second end; and,
a tightening device that attaches the second end of the extension portion to the main strap portion and that is adjustable to increase the tension of the corresponding strap.

15. The cover system of claim 14 wherein the cover comprises a storage pouch for each of the first and second ends of the first strap and the first and second ends of the second strap that is suitable to hold each of the first and second ends of the first strap and the first and second ends of the second strap when each of the first and second ends of the first strap and the first and second ends of the second strap is not attached to the associated open topped container.

16. The cover system of claim 15 wherein:
the attachment system comprises: first and second attachment cords each having first and second ends that are attached to the cover and a mid-portion that is exposed outside of the cover and that is attachable to the associated open topped container;
the cover comprises four corner regions; and,
the first attachment cord is positioned at one of the corner regions and the second attachment cord is positioned at the opposite corner region.

17. The cover system of claim 16 wherein:
the attachment system further comprises: third and fourth attachment cords each having first and second ends that are attached to the cover and a mid-portion that is exposed outside of the cover and that is attachable to the associated open topped container;
each of the third and fourth attachment cords is positioned at one of the remaining corner regions;
each of the first, second, third and fourth attachment cords is elastic;
the attachment system comprises a first cord lock that is adjustable to increase and decrease the length of the mid-portion of the third attachment cord; and,
the attachment system comprises a second cord lock that is adjustable to increase and decrease the length of the mid-portion of the fourth attachment cord.

18. The cover system of claim 17 wherein the first and second channel pockets are attached to the cover in a welding process.

19. A cover system suitable to cover an associated open topped container, the cover system comprising:
a cover comprising:
first and second sides that define a width;
first and second ends that define a length;
first and second channel pockets that are welded to the cover and that extend across at least 50% of the width of the cover;
a third channel pocket that is welded to the cover and that extends across at least 50% of the length of the cover;
wherein the perimeter of the cover comprises webbing reinforced in a hem over at least 50% of the perimeter of the cover; and,
wherein the cover is of sufficient size to enclose the open top of the associated open topped container; and,
an attachment system that is suitable to attach the cover to the associated open topped container, the attachment system comprising:
a first strap that is received within the first channel pocket and that comprises first and second ends that are attachable to the associated open topped container;
a second strap that is received within the second channel pocket and that comprises first and second ends that are attachable to the associated open topped container
a third strap that is received within the third channel pocket and that comprises first and second ends that are attachable to the associated open topped container; and,
wherein each of the first and second ends of the first, second and third straps comprises:
a main strap portion;
an extension portion comprising a first end that is attachable to the associated open topped container and a second end; and,
a tightening device that attaches the second end of the extension portion to the main strap portion and that is adjustable to increase the tension of the corresponding strap.

20. The cover system of claim 19 wherein:
the cover comprises four corner regions; and,
the attachment system comprises: first, second, third and fourth attachment cords each having first and second ends that are attached to the cover and a mid-portion that is exposed outside of the cover and that is attachable to the associated open topped container;
each of the first, second, third and fourth attachment cords is positioned at one of the corner regions of the cover, the first and third attachment cords are positioned at opposite corner regions;
each of the first, second, third and fourth attachment cords is elastic; and,
the attachment system further comprises:
a first cord lock that is adjustable to increase and decrease the length of the mid-portion of the first attachment cord; and,
a second cord lock that is adjustable to increase and decrease the length of the mid-portion of the third attachment cord.
